(19) United States
(12) Patent Application Publication
(10) Pub. No.: US 2022/0223871 A1
(43) Pub. Date: Jul. 14, 2022

(54) PROTECTIVE MATERIAL FOR NEGATIVE ELECTRODE OF LITHIUM METAL BATTERY, NEGATIVE ELECTRODE, AND MANUFACTURING METHOD THEREOF

(71) Applicant: Ningde Amperex Technology Limited, Ningde (CN)

(72) Inventors: Daguang LI, Ningde (CN); Maohua CHEN, Ningde (CN); Yuansen XIE, Ningde (CN); Peng DU, Ningde (CN)

(73) Assignee: Ningde Amperex Technology Limited, Ningde (CN)

(21) Appl. No.: 17/708,495

(22) Filed: Mar. 30, 2022

Related U.S. Application Data
(63) Continuation of application No. PCT/CN2020/125237, filed on Oct. 30, 2020.

(30) Foreign Application Priority Data
Nov. 13, 2019 (CN) 201911108965.1

(51) Int. Cl. H01M 4/62; H01M 10/052; H01M 4/04

(52) U.S. Cl. CPC H01M 4/62; H01M 2004/027; H01M 4/0402; H01M 10/052

(57) ABSTRACT

A protective material for a negative electrode of a lithium metal battery in this application includes a first protective layer and a second protective layer that are adjacent to each other. The first protective layer is contiguous to a lithium metal. Also, a method for manufacturing the protective material for a negative electrode of a lithium metal battery, and a method for manufacturing the negative electrode.

### CROSS REFERENCE TO RELATED APPLICATIONS

The present application is a bypass continuation application of PCT application PCT/CN2020/125237, filed on Oct. 30, 2020, which claims the benefit of priority from the China Patent Application No. 201911108965.1, filed on 13 Nov. 2019, the disclosure of which is hereby incorporated by reference in its entirety.

### TECHNICAL FIELD

This application relates to the field of energy storage technology, and in particular, to a protective material for a negative electrode of a lithium metal battery, a negative electrode that includes the protective material, and an electrochemical apparatus. This application further relates to a method for manufacturing the protective material for a negative electrode of a lithium metal battery, and a method for manufacturing the negative electrode.

### BACKGROUND

A lithium-ion battery has advantages such as a high specific energy, a high working voltage, a low self-discharge rate, a small size, and a light weight, and is widely applied in the field of consumer electronics. However, with rapid development of electric vehicles and portable electronic devices, people have higher requirements on energy density, safety, cycle performance, and the like of the battery. Among these parameters, a volumetric energy density and a mass energy density are important parameters for measuring battery performance.

Among all metal elements, lithium metal is a metal with the smallest relative atomic mass (6.94) and the lowest standard electrode potential (−3.045 V), and has a theoretical gram capacity up to 3860 mAh/g. Therefore, by using the lithium metal as a negative electrode of the battery accompanied by some positive electrode materials of a high energy density, the energy density of the battery and the working voltage of the battery can be greatly increased.

However, real commercialization of the battery that uses the lithium metal as a negative electrode material still faces the following problems:

1) the lithium metal itself is extremely active. Especially, a freshly generated lithium metal is very likely to have a series of side reactions with an existing organic small-molecule electrolyte system. Consequently, both the lithium metal and the electrolyte are consumed at the same time, a cycle Coulombic efficiency is typically lower than 99.5%, and a cycle Coulombic efficiency in a traditional liquid electrolyte system is typically lower than 90%, much lower than that (99%˜99.9%) in a general graphite negative electrode system.

2) during charging of the lithium metal battery, lithium will be deposited on a surface of a negative electrode current collector. A current density and a concentration of lithium ions in the electrolyte are inhomogeneous. Consequently, a deposition speed at some points will be too fast in a deposition process, and then a sharp dendrite structure will be formed. The existence of lithium dendrites will cause a deposition density to be greatly decreased. A true density of the lithium metal is approximately 0.534 g/cc, but an actual deposition density is only up to about 0.2 g/cc, thereby reducing the energy density of the lithium metal battery by more than 100 Wh/L. In severe cases, a separator may be penetrated to form a short circuit, causing safety problems.

3) a thickness of the negative electrode will violently expand and shrink while the lithium metal negative electrode is charged and discharged. A thickness of the expansion and shrinkage depends on a quantity of an active substance per unit area of an anode, and also depends on a lithium deposition density and a size of a side reaction product. The higher the quantity of the active material per unit area, the larger the expansion and shrinkage of the electrode. A higher lithium deposition density indicates denser lithium deposition, and leads to smaller expansion and shrinkage of the electrode. The severer the side reaction, the larger the side reaction product, and the larger the expansion of the electrode. According to general design of a commercial lithium-ion battery currently, a thickness of an anode generally varies from 8 to 200 μm. This will cause detachment of an interface between the negative electrode and a less flexible inorganic protection coating, and even lead to a rupture of the inorganic protective layer and a sharp increase in impedance. An impedance of some battery cells may increase from initial 2Ω to 20Ω.

Based on the above discussion, reducing the side reactions between the lithium metal and the electrolyte, suppressing growth of lithium dendrites, and solving the detachment of the interface and the rupture of the protective layer caused in the expansion-shrinkage process are necessary conditions for commercial application of lithium metal negative electrodes.

Currently, processes applied in the prior art to solve such problems can reduce side reactions. However, some organic solvents used in the processes, such as epoxy resin, naphthalene, naphthol, polyacrylic acid, and polyphosphoric acid, react directly with the lithium metal anode to produce bubbles, but polyethylene oxide, polyionic liquid, and the like cannot directly infiltrate the lithium metal, all of which lead to poor film quality of an organic protective layer.

### SUMMARY

To solve the foregoing problems, this application provides a protective material for a lithium metal negative electrode, including a first protective layer and a second protective layer that are adjacent to each other. The first protective layer is contiguous to a lithium metal.

In the protection material for a negative electrode according to this application, materials of the first protective layer include at least one of: Li₃PO₄, a lithium n-octadecyl phosphonic acid, LiI, LiCl, LiBr, a polymeric organic acid salt containing a —COOLi group (such as lithium polyacrylate or lithium polymethacrylate), ROLi, or RLi, where R includes a linear or branched alkyl group, a cycloalkyl group, or an aryl group. In some embodiments, R may include at least one of: methyl, ethyl, propyl, isopropyl, n-butyl, sec-butyl, tert-butyl, pentyl, hexyl, cyclohexyl, tert-octyl, n-eicosane, phenyl, methylphenyl, butylphenyl, naphthyl, and butylcyclohexyl. The second protective layer includes at least one of: an organic material, or an organic-inorganic composite.

In some embodiments, the organic material used for the second protective layer includes at least one of: PEO (polyethylene oxide), PVDF-HFP (polyvinylidene fluoride-hexafluoropropylene copolymer), PDMS (polydimethylsiloxane), PMMA (polymethyl methacrylate), or PIL (polyionic liquid); and the organic-inorganic composite used for the second protective layer includes at least one of the following composites: a composite of Al₂O₃ and PEO, a composite of SiO₂ and PEO, a composite of TiO₂ and PEO, a composite of LiTFSI (lithium bistrimethanesulfonimide) and PEO, a composite of LiBF₄ and PEO, a composite of LiClO₄ and PEO, a composite of LAGP (lithium aluminum germanium phosphate) and PEO, a composite of LATP (lithium aluminum titanium phosphate) and PEO, or a composite of LLZO (lithium lanthanum zirconate) and PEO.

A thickness of the protective material for a negative electrode according to this application may be approximately 0.02 microns to approximately 200 microns. In some embodiments, the first protective layer has a thickness of a nanometer scale. In some embodiments, a thickness of the second protective layer is approximately 1 micron.

This application further relates to a method for manufacturing a protective material for a negative electrode, including:

(1) using a solution with a lithium metal cleaning function to clean a lithium metal surface to form a first protective layer; and

(2) coating the first protective layer with a second protective layer.

This application further relates to a negative electrode, including the protective material for a negative electrode described herein or the protective material for a negative electrode that is manufactured according to the method described herein.

This application relates to an electrochemical apparatus, including the negative electrode described herein.

This application further relates to an electronic device, including the electrochemical apparatus described herein.

Additional aspects and advantages of the embodiments of this application will be described or illustrated in part later herein or expounded through implementation of the embodiments of this application.

### BRIEF DESCRIPTION OF DRAWINGS

For ease of describing the embodiments of this application, the following outlines the drawings necessary for describing the embodiments of this application or the prior art. Apparently, the drawings outlined below are only a part of embodiments in this application. Without making any creative efforts, a person skilled in the art can still obtain the drawings of other embodiments according to the structures illustrated in these drawings.

FIG. 1 is an original image, in the prior art, of coating a lithium metal with a second protective layer without a first protective layer provided according to the present invention;

FIG. 2 is a schematic diagram of the image shown in FIG. 1, in which an oblique line area is an area coated with the second protective layer, and a blank area indicates inhomogeneous coating of a solution of the second protective layer;

FIG. 3 shows an image of coating a protective material for a negative electrode according to a manufacturing process disclosed in this application, where the protective material for a negative electrode has a first protective layer and a second protective layer;

FIG. 4 is a schematic side view of a protective material for a negative electrode according to this application, where there is a lithium metal 3 on a copper foil 4, and the lithium metal 3 has two protective layers: a first protective layer 2 and a second protective layer 1, where the first protective layer 2 is contiguous to the lithium metal 3; and

FIG. 5 is a top view of a negative electrode manufactured according to this application, in which a protective material 5 for a negative electrode described herein homogeneously coats the negative electrode.

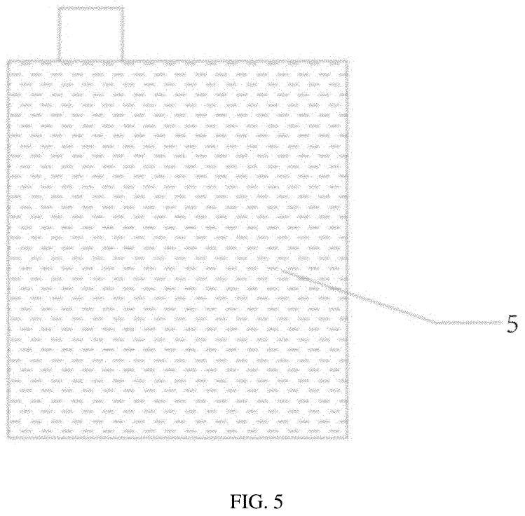

### DETAILED DESCRIPTION

Embodiments of this application will be described in detail below. Throughout the specification of this application, the same or similar components and the components having the same or similar functions are denoted by similar reference numerals. The embodiments described herein with reference to the accompanying drawings are illustrative and graphical in nature, and are intended to enable a basic understanding of this application. The embodiments of this application shall not be construed as a limitation on this application.

The terms “roughly,” “substantially,” “substantively”, and “approximately” used herein are intended to describe and represent small variations. When used with reference to an event or situation, the terms may denote an example in which the event or situation occurs exactly and an example in which the event or situation occurs very approximately. For example, when used together with a numerical value, the terms may denote a variation range falling within ±10% of the numerical value, such as ±5%, ±4%, ±3%, ±2%, ±1%, ±0.5%, ±0.1%, or ±0.05% of the numerical value. For example, if a difference between two numerical values falls within ±10% of an average of the numerical values (such as ±5%, ±4%, ±3%, ±2%, ±1%, ±0.5%, ±0.1%, or ±0.05% of the average), the two numerical values may be considered “substantially” the same.

In this specification, unless otherwise specified or defined, relativity terms such as “central”, “longitudinal”, “lateral”, “front”, “rear”, “right” “,” “left”, “internal”, “external”, “lower”, “higher”, “horizontal”, “perpendicular”, “higher than”, “lower than”, “above”, “under”, “top”, “bottom”, and derivative terms thereof (such as “horizontally”, “downwardly”, “upwardly”) shall be interpreted as a direction described in the context or a direction illustrated in the drawings. The relativity terms are used for ease of description only, and do not require that the construction or operation of this application should be in a specific direction.

Furthermore, for ease of description, “first”, “second”, “third”, and the like may be used herein to distinguish different components in one drawing or a series of drawings. “First”, “second”, “third”, and the like are not intended to describe corresponding components.

In addition, a quantity, a ratio, or another numerical value is sometimes expressed in a range format herein. Understandably, such a range format is for convenience and brevity, and shall be flexibly understood to include not only the numerical values explicitly specified and defined in the range, but also all individual numerical values or sub-ranges covered in the range as if each individual numerical value and each sub-range were explicitly specified.

In the description of embodiments and claims, a list of items referred to by using the terms such as “one of”, “one thereof”, “one type of” or other similar terms may mean any one of the listed items. For example, if items A and B are listed, the phrase “one of A and B” means: only A, or only B. In another example, if items A, B, and C are listed, then the phrase “one of A, B, and C” means: only A; only B; or only C. The item A may include a single component or a plurality of components. The item B may include a single component or a plurality of components. The item C may include a single component or a plurality of components.

In the description of embodiments and claims, a list of items referred to by using the terms such as “at least one of”, “at least one thereof”, “at least one type of” or other similar terms may mean any combination of the listed items. For example, if items A and B are listed, the phrase “at least one of A and B” means: only A; only B; or both A and B. In another example, if items A, B, and C are listed, the phrase “at least one of A, B, and C” means: only A; only B; only C; A and B (excluding C); A and C (excluding B); B and C (excluding A); or all of A, B, and C. The item A may include a single component or a plurality of components. The item B may include a single component or a plurality of components. The item C may include a single component or a plurality of components.

The term “alkyl group” is intended to be a linear saturated hydrocarbon structure having 1 to 20 carbon atoms. “Alkyl group” is further intended to be a branched or cyclic hydrocarbon structure having 3 to 20 carbon atoms. For example, an alkyl group may be an alkyl group of 1 to 20 carbon atoms, an alkyl group of 1 to 10 carbon atoms, an alkyl group of 1 to 5 carbon atoms, an alkyl group of 5 to 20 carbon atoms, an alkyl group of 5 to 15 carbon atoms, or an alkyl group of 5 to 10 carbon atoms. References to an alkyl group with a specific number of carbon atoms are intended to cover all geometric isomers with the specific number of carbon atoms. Therefore, for example, “butyl” is meant to include n-butyl, sec-butyl, isobutyl, tert-butyl, and cyclobutyl; and “propyl” includes n-propyl, isopropyl, and cyclopropyl. Examples of alkyl groups include, but are not limited to, methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like. In addition, the alkyl group may be optionally replaced.

The term “cycloalkyl group” covers cyclic alkyl groups. A cycloalkyl group may be a cycloalkyl group of 3 to 20 carbon atoms, a cycloalkyl group of 6 to 20 carbon atoms, a cycloalkyl group of 3 to 10 carbon atoms, or a cycloalkyl group of 3 to 6 carbon atoms. For example, a cycloalkyl group may be a cyclopropyl, cyclobutyl, cyclopentyl, cyclohexyl, or the like. In addition, the cycloalkyl group may be optionally replaced.

The term “aryl group” covers a monocyclic system and a polycyclic ring system. Polycyclic may refer to two or more rings, of which two adjacent rings (which are “condensed”) share two carbon atoms, at least one of the rings is aromatic, and another ring may be, for example, a cycloalkyl group, a cycloalkenyl group, an aryl group, or a heterocyclic and/or heteroaryl group. For example, an aryl group may be a C6-C50 aryl group, a C6-C40 aryl group, a C6-C30 aryl group, a C6-C20 aryl group, or a C6-C10 aryl group. Representative aryl groups include (for example) phenyl, methylphenyl, propylphenyl, isopropylphenyl, benzyl, naphth-1-yl, naphth-2-yl, and the like. In addition, the aryl group may be optionally replaced.

I. Protective Material for a Lithium Metal Negative Electrode

A first aspect of this application relates to a protective material for a lithium metal negative electrode, including a first protective layer and a second protective layer that are adjacent to each other. The first protective layer is contiguous to a lithium metal.

In the protective material for a negative electrode according to this application, materials of the first protective layer include at least one of: Li₃PO₄, a lithium n-octadecyl phosphonic acid, LiI, LiCl, LiBr, a polymeric organic acid salt containing a —COOLi group, ROLi, or RLi, wherein R includes a linear or branched alkyl group, a cycloalkyl group, or an aryl group. In some embodiments, R may include at least one of: methyl, ethyl, propyl, isopropyl, n-butyl, sec-butyl, tert-butyl, pentyl, hexyl, cyclohexyl, tert-octyl, n-eicosane, phenyl, methylphenyl, butylphenyl, naphthyl, or butylcyclohexyl. In some embodiments, the polymeric organic acid salt containing a —COOLi group includes at least one of lithium polyacrylate (PAALi) or lithium polymethacrylate.

In some embodiments, the second protective layer includes at least one of: an organic material, and an organic-inorganic composite. In some embodiments, the second protective layer further includes a base material. The base material is a lithium salt for increasing ionic conductivity, and is preferably LiTFSI, LiFSI, or LiPF.

In this application, the material of the second protective layer is characterized by a good infiltrative effect between the material of the second protective layer and a material of the first protective layer described herein, so that the second protective layer is homogeneously distributed on the first protective layer.

In some embodiments, the organic material used for the second protective layer includes at least one of: PEO, PVDF-HFP, PDMS, PMMA, or PIL. PIL includes a mixture of S-ImTFS, a lithium salt, and IL. The lithium salt includes at least one of: LiFSI, LiTFSI, or LiPF₆. Ions in the IL include at least one of: a quaternary ammonium salt ion, a quaternary phosphonium salt ion, an imidazole salt ion, a pyrrole salt ion, a halogen ion, a tetrafluoroborate ion, or a hexafluorophosphate ion.

In some embodiments, the organic-inorganic composite used for the second protective layer includes at least one of the following materials: a composite of Al₂O₃ and PEO, a composite of SiO₂ and PEO, a composite of TiO₂ and PEO, a composite of LiTFSI and PEO, a composite of LiBF₄ and PEO, a composite of LiClO₄ and PEO, a composite of LAGP and PEO, a composite of LATP and PEO, or a composite of LLZO and PEO.

In some embodiments, the organic material used for the second protective layer is PEO. In some embodiments, the composite used for the second protective layer is a composite of Al₂O₃ and PEO.

In some embodiments, when the second protective layer is PEO, the material of the first protective layer may include any of: Li₃PO₄, lithium n-octadecyl phosphonic acid, LiI, lithium polyacrylate, and ROLi. Preferably, the material of the first protective layer contained in the protective material for the negative electrode according to this application is Li₃PO₄, and the material of the second protective layer contained therein is PEO.

In some embodiments, when the second protective layer is a composite of Al₂O₃ and PEO, the material of the first protective layer may include any of: Li₃PO₄, lithium n-octadecyl phosphonic acid, LiI, lithium polyacrylate, and ROLi. Preferably, the material of the first protective layer contained in the protective material for the negative electrode according to this application is Li₃PO₄ or lithium polyacrylate, and the material of the second protective layer contained therein is a composite of Al₂O₃ and PEO.

The material of the second protective layer used in this application has good flexibility, and therefore, can adapt to changes of size of metallic lithium occurring during charging or discharging of an electrochemical apparatus, thereby improving safety performance and cycle performance of the electrochemical apparatus.

The protective material for a negative electrode according to this application may further include one or more other protective layers, the material of which is the same as or different from that of the first protective layer or the second protective layer. For example, the one or more other protective layers contained in the protective material for a negative electrode according to this application include at least one of PEO, PVDF-HFP, PDMS, PMMA, or PIL. In some embodiments, the one or more other protective layers are located between the first protective layer and the second protective layer, or may be located on a side, on the second protective layer, opposite to the first protective layer.

A thickness of the protective material for a negative electrode according to this application may be approximately 0.02 microns to approximately 200 microns. For example, the thickness of the protective material for a negative electrode is approximately 0.05 microns, approximately 0.5 microns, approximately 1 micron, approximately 5 microns, approximately 10 microns, approximately 20 microns, approximately 30 microns, approximately 40 microns, approximately 50 microns, approximately 60 microns, approximately 70 microns, approximately 80 microns, approximately 90 microns, approximately 100 microns, approximately 150 microns, or any range therebetween.

In some embodiments, the first protective layer has a thickness of a nanometer scale, for example, a thickness of approximately 50 nanometers, approximately 60 nanometers, approximately 70 nanometers, approximately 80 nanometers, approximately 90 nanometers, approximately 95 nanometers, approximately 100 nanometers, approximately 150 nanometers, or any range therebetween.

In some embodiments, a thickness of the second protective layer is greater than or equal to 1 micron. In other embodiments, a thickness of the second protective material may be approximately 2 microns, approximately 3 microns, approximately 4 microns, approximately 5 microns, approximately 6 microns, approximately 7 microns, approximately 8 microns, approximately 9 microns, approximately 10 microns, or any range therebetween.

Currently, an inorganic protective material for a negative electrode used for a lithium metal battery in the prior art is likely to rupture during cycling. That is because the size of metal lithium changes greatly during cycling of the battery, but inorganic materials are generally inferior in flexibility and strength, and are vulnerable to a rupture or an interface detachment due to inability of adapting to a stress caused by the great change of the size. Although an organic protective material for a negative electrode is relatively flexible and can adapt to the change of the size, the organic material cannot infiltrate a lithium metal surface, resulting in an inhomogeneous film thickness and poor film quality.

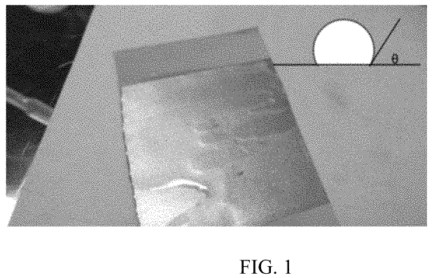

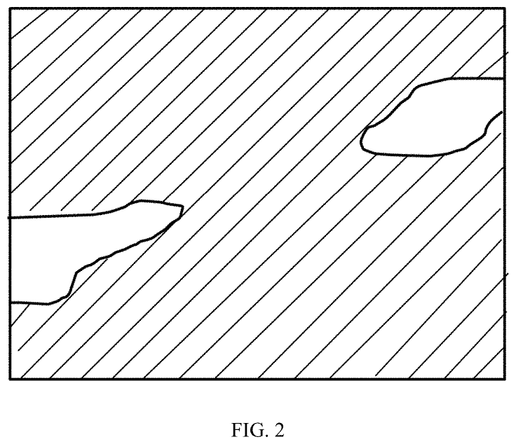

As shown in FIG. 1 and FIG. 2, when the first protective layer according to this application is absent, an organic solution cannot be spread homogeneously on a surface of a substrate. Consequently, the film thickness is inhomogeneous, and even some parts are not covered by any solution at all.

According to this application, the first protective layer for a lithium metal negative electrode material described above can unexpectedly improve the infiltration between the second protective layer and the negative electrode material, and enable the second protective layer to be homogeneously spread on the negative electrode material, thereby forming a dense protective film. In addition, the second protective layer used in this application can adapt to the change of the size of the metallic lithium during the cycling, and prevent the protective material for a negative electrode from rupturing during use. The protective material for a negative electrode according to this application, especially a double-layer negative electrode protection structure that includes the first protective layer and the second protective layer, can form a homogeneous and dense protective film. The protective film can effectively suppress generation of lithium dendrites and improve deposition of lithium metal on the protective material, thereby significantly optimizing rate performance of the lithium metal battery and improving safety and cycle performance of the lithium metal battery.

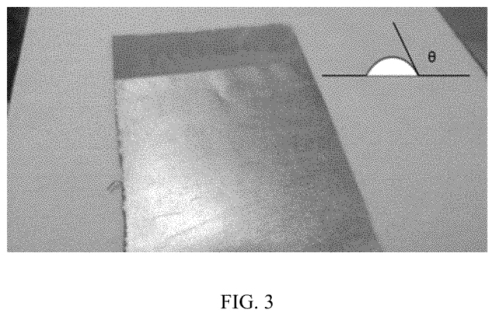

As shown in FIG. 3, in a case that the first protective layer according to this application exists, the second protective layer is spread homogeneously on the first protective layer to form a homogeneous and dense protective film.

II. Method for Manufacturing a Protective Material for a Lithium Metal Negative Electrode

A protective film for a negative electrode, which is of an organic material, is generally manufactured by coating metallic lithium with an organic solvent. However, an oxide layer may be generated on a lithium metal surface during storage of a lithium metal, and the oxide layer deteriorates infiltration between the metallic lithium and the organic solvent (a solution cannot be spread homogeneously on a surface of a substrate), resulting in an inhomogeneous film thickness, as shown in FIG. 1. In addition, some organic solvents, such as epoxy resin, naphthalene, naphthol, polyacrylic acid, and polyphosphoric acid, which are of a high concentration, may react with the metallic lithium to generate bubbles, thereby deteriorating film quality.

Therefore, this application further provides a method for manufacturing the protective material for a negative electrode on a lithium metal, including:

(1) using a solution with a lithium metal cleaning function to clean a lithium metal surface to form a first protective layer; and

(2) coating the first protective layer with a second protective layer.

In some embodiments, the solution with a lithium metal cleaning function includes an ingredient A, and the ingredient A includes at least one of: naphthol, polyacrylic acid, polymethacrylic acid, polyphosphoric acid, naphthalene, n-octadecyl phosphoric acid, I₂, Br₂, or Cl₂. In some embodiments, the solution with a lithium metal cleaning function may further include an ingredient B. The ingredient B includes at least one of: acetonitrile, tetrahydrofuran, dimethyl sulfoxide, or N-methylpyrrolidone.

In some embodiments, a concentration of the ingredient A in the cleaning solution is approximately 0.05 wt % to approximately 5 wt %. In some embodiments, the concentration of the ingredient A in the cleaning solution is approximately 0.1 wt %, approximately 0.2% wt %, approximately 0.5 wt %, approximately 0.7 wt %, approximately 1.0% wt %, approximately 2.0 wt %, approximately 3.0 wt %, approximately 4.0% wt %, or any range therebetween.

In the method according to this application, the cleaning in step (1) includes: immersing the lithium metal in a prepared solution for a period of time. In some embodiments, the cleaning continues for approximately 5 to 15 minutes, for example, approximately 6 minutes, approximately 7 minutes, approximately 8 minutes, approximately 9 minutes, approximately 10 minutes, approximately 11 minutes, approximately 12 minutes, approximately 13 minutes, or approximately 14 minutes.

In the cleaning process, an organic acid or an inorganic acid in the solution can purge impurities on the lithium metal surface and also generate a first protective layer on the lithium metal surface. The first protective layer generally has a thickness of a nanometer scale. Due to good infiltration between the first protective layer and the second protective layer, compared with a single-layer organic protective structure without the first protective layer, the double-layer protective film manufactured for a negative electrode according to the process disclosed in this application is denser, and has a more homogeneous thickness and a better protection effect.

For example, when the solution for cleaning contains a polyphosphoric acid, the polyphosphoric acid may react with Li, Li₂O, LiOH, and Li₂CO₃ so that the following chemical reactions occur:

2H₃PO₄+6Li→2Li₃PO₄+3H₂↑

2H₃PO₄+3Li₂O→2Li₃PO₄+3H₂O

H₃PO₄+3LiOH→Li₃PO₄+3H₂O

2H₃PO₄+3Li₂CO₃→2Li₃PO₄+3H₂O+3CO₂↑

P₂O₅+3H₂O→2H₃PO₄

Through the above series of chemical reactions, a first protective layer of a thickness of a nanometer scale, namely, a Li₃PO₄ protective layer, is generated on the lithium metal surface while impurities on the lithium metal surface are purged. After the first protective layer is formed, an organic solution is applied onto the first protective layer to form a second protective layer.

FIG. 1 and FIG. 2 show a circumstance in which the second protective layer directly forms a coating without performing step (1) in the method of this application. FIG. 2 is a schematic diagram of FIG. 1. As can be seen from FIG. 1 and FIG. 2, the coating of the solution of the second protective layer is extremely inhomogeneous, and some areas are even not coated at all. In comparison, as shown in FIG. 3, according to the process described in this application, the cleaning in step (1) is performed first before the material of the second protective layer is applied, thereby unexpectedly improving infiltration and homogeneity of the coating of the second protective layer. According to a comparison between FIG. 1 and FIG. 3, due to the use of the first protective layer in FIG. 3, an infiltration angle between the solution of the second protective layer and the electrode changes from an acute angle (indicating poor infiltration) to an obtuse angle (indicating good infiltration). Therefore, compared with the prior art, the manufacturing process provided in this application obtains a more homogeneous and denser protective film for a negative electrode.

For example, the step of forming the coating of the second protective layer includes: mixing the organic material described above or a mixture of the organic material and an inorganic material, which is used for the second protective layer, with a base material and a solvent. The base material is a lithium salt used for increasing ion conductivity, and is preferably LiTFSI, LiFSI, or LiPF₆. Then, according to an existing coating method (such as a spread plate method), a mixture thereby obtained is applied onto the first protective layer described herein.

III. Others

This application further relates to a negative electrode, including the protective material for a negative electrode described herein or the protective material for a negative electrode that is manufactured according to the method described herein.

This application relates to an electrochemical apparatus, including the negative electrode described herein.

This application further relates to an electronic device, including the electrochemical apparatus described herein.

The electrochemical apparatus according this application includes any apparatus in which an electrochemical reaction occurs. Specific examples of the apparatus include all kinds of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery, or a lithium-ion polymer secondary battery. In some embodiments, the electrochemical apparatus is a lithium-ion battery.

In some embodiments, the electrochemical apparatus according to this application includes a positive electrode, a negative electrode, and a separator. The positive electrode contains a positive-electrode active material, and the negative electrode contains a negative-electrode active material.

Positive Electrode

In the electrochemical apparatus according to this application, a positive electrode includes a current collector and a positive-electrode active material layer disposed on the current collector. Specific types of the positive-electrode active material are not limited, and may be selected according to needs.

For example, in some implementation solutions, the positive-electrode active material includes a compound that reversibly intercalates and deintercalates lithium ions. In some implementation solutions, the positive-electrode active material may include a composite oxide. The composite oxide contains lithium and at least one element selected from cobalt, manganese, and nickel. In other implementation solutions, the positive-electrode active material includes at least one of: a lithium cobalt oxide (LiCoO₂), a lithium nickel-manganese-cobalt ternary material, a lithium manganese oxide (LiMn₂O₄), a lithium nickel manganese oxide (LiNi_{0.5}Mn_{1.5}O₄), or a lithium iron phosphate (LiFePO₄).

In some implementation solutions, the positive-electrode active material layer may have a coating on its surface, or may be mixed with another compound having a coating.

The coating may include at least one compound of a coating element, which is selected from: an oxide of a coating element, a hydroxide of a coating element, an oxyhydroxide of a coating element, an oxycarbonate of a coating element, and a hydroxycarbonate of a coating element.

The compound used for the coating may be amorphous or crystalline.

The coating element included in the coating may include Mg, Al, Co, K, Na, Ca, Si, Ti, V, Sn, Ge, Ga, B, As, Zr, or F, or a mixture thereof.

The coating may be applied in any method as long as the method does not adversely affect performance of the positive-electrode active material. For example, the method may include any coating method well known to a person of ordinary skill in the art, such as spraying and infiltrating.

In some implementation solutions, the positive-electrode active material layer further includes a binder, and optionally, further includes a conductive material.

The binder improves bonding between particles of the positive-electrode active material and bonding between the positive-electrode active material and a current collector. Examples of the binder include but without limitation: polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, and nylon.

The positive-electrode active material layer includes the conductive material, thereby making the electrode electrically conductive. The conductive material may include any conductive material that does not cause a chemical change. Examples of the conductive material include but without limitation: a carbon-based material (for example, natural graphite, artificial graphite, carbon black, acetylene black, Ketjen black, and carbon fiber), a metal-based material (for example, metal powder, and metal fiber, including copper, nickel, aluminum, silver, and the like), a conductive polymer (for example, a polyphenylene derivative), and any mixture thereof.

The current collector used for the positive electrode of the secondary battery according to this application may be, but is not limited to, aluminum (Al).

Separator

In some embodiments, the electrochemical apparatus according to this application has a separator disposed between the positive electrode and the negative electrode to prevent short circuit. The material and the shape of the separator used in the electrochemical apparatus according to this application are not particularly limited, and may be based on any technology disclosed in the prior art. In some embodiments, the separator includes a polymer or an inorganic substance or the like formed of a material that is stable to the electrolyte according to this application.

For example, the separator may include a substrate layer and a surface treatment layer.

The substrate layer is a non-woven fabric, film or composite film, each having a porous structure. The material of the substrate layer includes at least one of: polyethylene, polypropylene, polyethylene terephthalate, or polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

A surface treatment layer is disposed on at least one surface of the substrate layer. The surface treatment layer may be a polymer layer or an inorganic substance layer, or a layer formed by mixing a polymer and an inorganic substance.

The inorganic substance layer includes inorganic particles and a binder. The inorganic particles include at least one of: an aluminum oxide, a silicon oxide, a magnesium oxide, a titanium oxide, a hafnium dioxide, a tin oxide, a ceria, a nickel oxide, a zinc oxide, a calcium oxide, a zirconium oxide, a yttrium oxide, a silicon carbide, a boehmite, an aluminum hydroxide, a magnesium hydroxide, a calcium hydroxide, or a barium sulfate. The binder includes at least one of: a polyvinylidene fluoride, a vinylidene fluoride-hexafluoropropylene copolymer, a polyamide, a polyacrylonitrile, a polyacrylate, a polyacrylic acid, a polyacrylate, a polyvinylpyrrolidone, a polyvinyl ether, a poly methyl methacrylate, a polytetrafluoroethylene, or a polyhexafluoropropylene.

The polymer layer includes a polymer, and the material of the polymer includes at least one of: a polyamide, a polyacrylonitrile, an acrylate polymer, a polyacrylic acid, a polyacrylate, a polyvinylpyrrolidone, a polyvinyl ether, a polyvinylidene fluoride, or a poly(vinylidene fluoride-hexafluoropropylene).

Another aspect of this application provides an electronic apparatus, including the electrochemical apparatus according to this application.

The electrochemical apparatus according to this application is applicable to electronic devices in various fields. The electrochemical apparatus according to this application may be used for purposes not particularly limited, and may be used for any purpose known in the prior art. In an embodiment, the electrochemical apparatus according to this application is applicable to, but without limitation, the following electronic apparatuses: a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

The following substances are involved in this application:

| Abbreviation | Full name |
|---|---|
| ACN | Acetonitrile |
| LiFSI | Lithium bis(fluorosulfonyl)imide |
| PEO | Polyethylene oxide |
| EC | Ethylene carbonate |
| EMC | Ethyl methyl carbonate |
| DEC | Diethyl carbonate |
| LiPF₆ | Lithium hexafluorophosphate |
| PE | Polyethylene |
| DMSO | Dimethyl sulfoxide |
| PAA | Polyacrylic acid |
| PPA | Polyphosphoric acid |
| PVDF-HFP | Polyvinylidene fluoride-hexafluoropropylene copolymer |
| DMF | N,N-dimethylformamide |
| THF | Tetrahydrofuran |
| S-ImTFS | Poly(styrene-b-1-((2-acryloxy)ethyl)-3- |
| | butylimidazole)bis(trifluoromethanesulfonyl)imide) |
| PDMS | Polydimethylsiloxane |
| PMMA | Polymethylmethacrylate |
| PIL | Polyionic liquid |
| IL | Ionic liquid |
| LiTFSI | Lithium bistrimethanesulfonimide |
| LAGP | Lithium aluminum germanium phosphate |
| LATP | Lithium aluminum titanium phosphate |
| LLZO | Lithium lanthanum zirconate |

### EMBODIMENTS

The following describes implementation solutions of this application with examples with reference to embodiments. Understandably, the embodiments are only intended to illustrate this application but not to limit the protection scope claimed by this application.

### Embodiment 1

1. Manufacturing of an Electrode

1.1 Manufacturing of a First Protective Layer, Including:

preparing a naphthol tetrahydrofuran solution: adding 1.44 g of naphthol into 60 mL (0.167 M) of tetrahydrofuran; and immersing a lithium metal electrode in the naphthol tetrahydrofuran solution for 15 minutes, and performing drying at 50° C. for 2 hours in a vacuum environment to form the first protective layer (naphthol-Li).

1.2 Manufacturing of a Second Protective Layer, Including:

adding PEO powder and LiFSI powder into ACN, where a mass ratio of the PEO to the ACN is 0.5%, and a molar ratio of the PEO to the LiFSI is 20:1; and coating, after stirring homogeneously, the first protective layer with the ACN by using a tablet coating machine, so as to form the second protective layer (PEO), as shown in FIG. 3. A thickness of the second protective layer is approximately 1 μm, and an areal density thereof is approximately 0.2 kg/m².

1.3 Manufacturing of the Electrode, Including:

cutting the lithium metal electrode subjected to the above steps into a size of (40 mm×60 mm) for use.

2. Manufacturing of an Electrolyte, Including:

mixing organic solvents ethylene carbonate (EC), ethyl methyl carbonate (EMC), and diethyl carbonate (DEC) at a mass ratio of 30:50:20 in an dry argon atmosphere first, and then adding lithium hexafluorophosphate (LiPF₆) into the organic solvents to dissolve, and mixing the organic solvents homogeneously to obtain an electrolyte in which a lithium salt concentration is 1.15 M.

3. Manufacturing of a Lithium-Ion Battery, Including:

using polyethylene (PE) with a thickness of 15 μm as a separator disposed between an upper layer and a lower layer, where both the upper layer and the lower layer are electrode s; after lamination, fixing four corners of an entire laminate structure by using an adhesive tape, and then placing the laminate structure into an aluminum laminated film; and performing top-side sealing, electrolyte injection, and packaging to ultimately obtain a laminated lithium metal battery.

### Embodiment 2

1. Manufacturing of an Electrode

1.1 Manufacturing of a First Protective Layer, Including:

adding a polyacrylic acid (PAA, 9003-01-4) into a dimethyl sulfoxide (DMSO) solution, where a mass ratio of the PAA to the DMSO is 0.2%; stirring homogeneously; and immersing a lithium metal electrode in the prepared solution for 2 minutes, and performing drying at 50° C. for 2 hours in a vacuum environment to form the first protective layer (PAALi).

1.2 Manufacturing of a Second Protective Layer

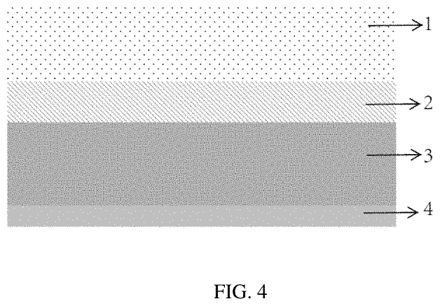

The manufacturing steps are the same as those of Embodiment 1. A thickness of the second protective layer is approximately 1 μm, and an areal density thereof is approximately 0.2 kg/m². After coating, a structure shown in FIG. 4 is obtained.

1.3 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Embodiment 3

1. Manufacturing of an Electrode

1.1 Manufacturing of a First Protective Layer, Including:

adding a polyphosphoric acid (PPA) into a dimethyl sulfoxide (DMSO) solution, where a mass ratio of the PPA to the DMSO is 0.05%; stirring homogeneously; and immersing a lithium metal electrode in the prepared solution for 2 minutes, and performing drying at 50° C. for 2 hours in a vacuum environment to form the first protective layer (Li₃PO₄).

1.2 Manufacturing of a Second Protective Layer

The manufacturing steps are the same as those of Embodiment 1. A thickness of the second protective layer is approximately 1 μm, and an areal density thereof is approximately 0.2 kg/m². After coating, a structure shown in FIG. 4 is obtained.

1.3 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Embodiment 4

1. Manufacturing of an Electrode

1.1 Manufacturing of a First Protective Layer

The manufacturing of the first protective layer (PAALi) is the same as that described in Embodiment 2.

1.2 Manufacturing of a Second Protective Layer

adding PEO powder, LiFSI powder, and Al₂O₃ powder into acetonitrile (ACN), where a mass ratio of the PEO to the ACN is 0.5%, a molar ratio of the PEO to the LiFSI is 20:1, and a mass ratio of the PEO to the Al₂O₃ is 4:1; and coating, after stirring homogeneously, the first protective layer with the ACN by using a tablet coating machine, so as to form the second protective layer (PEO+Al₂O₃). A thickness of the second protective layer is approximately 1 μm, and an areal density thereof is approximately 0.86 kg/m².

1.3 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Comparative Embodiments 1 to 3

1. Manufacturing of an Electrode

An electrode in Comparative Embodiments 1 to 3 only has a first protective layer according to this application, but has no second protective layer.

Specifically, manufacturing steps of the protective layer in Comparative Embodiments 1 to 3 are the same as a manufacturing process of the first protective layer in Embodiments 1 to 3, including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Comparative Embodiments 4 to 6

1. Manufacturing of an Electrode

An electrode in Comparative Embodiments 4 and 6 only has a second protective layer according to this application, but has no first protective layer. An electrode in Comparative Embodiment 5 has neither a first protective layer nor a second protective layer.

Specifically, manufacturing steps of the second protective layer in Comparative Embodiments 4 and 6 are the same as the manufacturing steps of the second protective layer in Embodiments 1 and 4, except that the second protective layer in Comparative Embodiments 4 and 6 is formed by directly coating a lithium metal by using a tablet coating machine.

As shown in FIG. 1 and FIG. 2, in a case of having no first protective layer according to the present invention, the second protective layer is distributed on the electrode in an extremely inhomogeneous manner, and even some areas are not coated with any protective layer material at all, thereby leading to inability of forming a homogeneous protective film.

Manufacturing of the electrode includes: cutting the lithium metal electrode, which is subjected to the above steps in Embodiments 4 and 6, and the lithium metal electrode, which is not subjected to any treatment in Comparative Embodiment 5, into a size of (40 mm×60 mm) for use.

2. Manufacturing of an Electrolyte and Manufacturing of a Lithium-Ion Battery

The specific manufacturing steps are the same as those of Embodiment 1.

### Comparative Embodiment 7

1. Manufacturing of an Electrode

1.1 Manufacturing of a Protective Layer of the Electrode, Including:

adding iodine into a dimethyl sulfoxide (DMSO) solution, where a molar mass ratio of the iodine to the DMSO is 0.25; stirring homogeneously; and immersing a lithium metal electrode in the prepared solution for 2 minutes, and performing drying at 50° C. for 2 hours in a vacuum environment to form a protective layer (LiI) of the lithium metal electrode.

1.2 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Comparative Embodiment 8

1. Manufacturing of an Electrode

1.1 Manufacturing of a Protective Layer of the Electrode, Including:

adding PVDF-HFP powder into a mixed solution of N,N-dimethylformamide (DMF) and a liquid electrolyte (1M LiClO₄ in a mixed solution of ethylene carbonate (EC) and propylene carbonate (PC), with a volume ratio of EC to PC being 1:1), where a mass ratio of the PVDF-HFP to the DMF is 1:20, and a mass ratio of the PVDF-HFP to the liquid electrolyte is 1:3; coating, after stirring the mixed solution homogeneously, a negative electrode with the mixed solution by using a tablet coating machine; and cooling the negative electrode at 20° C. for 2 hours in a vacuum environment to form a protective layer (PVDF-HFP) of a negative electrode. A thickness of the protective layer of the negative electrode is approximately 1 μm, and an areal density thereof is approximately 0.3 kg/m².

1.2 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

### Comparative Embodiment 9

1. Manufacturing of an Electrode

1.1 Manufacturing of a Protective Layer of the Electrode, Including:

adding LiFSI powder, S-ImTFS powder, and an IL liquid (that is, 3-butylimidazole-bis(trifluoromethanesulfonyl)imide) into a tetrahydrofuran (THF) solution, where a mass ratio of the LiFSI, the S-ImTFS, the IL, and the THF is 0.5:4:0.5:95; coating, after stirring the solution homogeneously, the negative electrode with the solution by using a tablet coating machine; and cooling the negative electrode at 20° C. for 10 hours in a vacuum environment to form a protective layer (PIL) of the electrode. A thickness of the protective layer of the negative electrode is approximately 1 μm, and an areal density thereof is approximately 0.1 kg/m².

1.2 Manufacturing of the Electrode, Including:

cutting the lithium metal electrode subjected to the above steps into a size of (40 mm×60 mm) for use.

2. Manufacturing of an Electrolyte and Manufacturing of a Lithium-Ion Battery

The specific manufacturing steps are the same as those of Embodiment 1.

With respect to the technical solutions in the above comparative embodiments and the above embodiments, a final number of cycles of each different anode-protected symmetric battery before short circuiting is used to represent the technical effects achieved. A sudden drop in a potential of the symmetric battery during a cycle (generally a drop to 40 mV) is generally called a short circuit of the symmetric battery (the change in the potential of the symmetric battery during the cycle is measured by LAND or NEWARE), where a current density is 1 mA/cm². For specific data, see the following table.

Method for testing the number of cycles of the symmetric battery, including:

discharging and charging the symmetrical battery, in each case, for 15 hours at a current density of 0.1 mA/cm² to activate the battery; cycling the symmetric battery at a current density of 0.6 mA/cm², in which both a discharge period and a charge period are set to 3 hours; reading the number of cycles through an electrochemical test curve that is output by LAND or NEWARE, where, if the potential suddenly drops to less than 40 mV, it is considered that the battery is short-circuited, and each occasion of rise and drop of voltage before the short circuiting of the battery is counted as one cycle of the battery; and then reading the number of cycles manually.

| | | | Number of |
|---|---|---|---|
| | | | cycles of the |
| | First protective | Second protective | symmetric |
| | layer/thickness | layer/thickness | battery |
| Embodiment | Naphthol-Li/0.1 μm | PEO/1 μm | 55 |
| 1 | | | |
| Embodiment | PAALi/0.1 μm | PEO/1 μm | 80 |
| 2 | | | |
| Embodiment | Li₃PO₄/0.1 μm | PEO/1 μm | 70 |
| 3 | | | |
| Embodiment | PAALi/0.1 μm | Al₂O₃ + PEO/1 μm | 90 |
| 4 | | | |
| Comparative | Naphthol-Li/0.1 μm | N/A | 50 |
| Embodiment | | | |
| 1 | | | |
| Comparative | PAALi/0.1 μm | N/A | 65 |
| Embodiment | | | |
| 2 | | | |
| Comparative | Li₃PO₄/0.1 μm | N/A | 60 |
| Embodiment | | | |
| 3 | | | |
| Comparative | N/A | PEO/1 μm | 30 |
| Embodiment | | | |
| 4 | | | |
| Comparative | N/A | N/A | 50 |
| Embodiment | | | |
| 5 | | | |
| Comparative | N/A | Al₂O₃ + PEO/1 μm | 40 |
| Embodiment | | | |
| 6 | | | |
| Comparative | LiI | N/A | 35 |
| Embodiment | | | |
| 7 | | | |
| Comparative | N/A | PVDF-HFP/1 μm | 30 |
| Embodiment | | | |
| 8 | | | |
| Comparative | N/A | PIL/1 μm | 20 |
| Embodiment | | | |
| 9 | | | |

As can be seen from the data in the above table, the technical solution of this application achieves beneficial technical effects. For example, Embodiment 4 achieves optimum technical effects, in which the material of the first protective layer is PAALi, and the material of the second protective layer is Al₂O₃+PEO.

On the other hand, the comparison between the Embodiments and the Comparative Embodiments proves that a single protective layer of a negative electrode cannot effectively improve the cycle performance of the battery, and in some circumstances, may even deteriorate the cycle performance of the battery (for example, in Comparative Embodiment 4). That is because, in Comparative Embodiment 4, infiltration between the protective material PEO for the negative electrode and the lithium metal is extremely poor (FIG. 1), and the spreading of the PEO solution on the lithium metal is inhomogeneous, thereby resulting in defects of the protective layer of the negative electrode. The lithium metal deposits faster at such defect points, and forms sharp dendrites that penetrate the separator, thereby causing a short circuit of the battery and deteriorating the cycle performance of the battery. In Comparative Embodiments 2 and 3, although the PPA and the PAA have some effects of improving the cycle performance of the battery, the PPA and the PAA are formed by reacting the solution and the lithium metal, and the thickness of the PPA and the PAA can hardly be controlled effectively, and consequently the improvement effect is limited. In addition, due to the very small thickness, the PPA and the PPA are very likely to rupture during the cycles to lose the protective effect.

The infiltration on a surface of a solid mainly depends on properties of atoms or atomic groups on an interface layer. Therefore, with respect to the solid, the infiltration on the solid varies sharply with composition and properties of a solid phase and a liquid phase. With respect to a solid on which a surface modifier is applied, the infiltration on the solid does not depend on properties of a substrate of the solid, but mainly depends on properties of the modifier and the liquid phase. The method for manufacturing a protective layer material for a negative electrode according to the present invention can modify properties of a surface of the negative electrode material of a lithium metal battery. By using a material that has a cleaning effect (namely, a surface modifier), the infiltration between the second protection layer and the lithium metal is significantly improved while the first protective layer is formed, thereby obtaining a double-layer protective layer closely connected to the lithium metal, achieving a double protective effect, and significantly improving the cycle performance of the battery.

References to “embodiments”, “some embodiments”, “an embodiment”, “another example”, “example”, “specific example” or “some examples” throughout the specification mean that at least one embodiment or example in this application includes specific features, structures, materials, or characteristics described in the embodiment(s) or example(s). Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment or example in this application. In addition, specific features, structures, materials, or characteristics herein may be combined in one or more embodiments or examples in any appropriate manner.

Although illustrative embodiments have been demonstrated and described above, a person skilled in the art understands that the above embodiments shall not be construed as a limitation on this application, and changes, replacements, and modifications may be made to the embodiments without departing from the spirit, principles, and scope of this application.

What is claimed is:

1. A protective material for a negative electrode of a lithium metal battery, the protective material comprising: a first protective layer and a second protective layer adjacent to the first protective layer, wherein the first protective layer is contiguous to a lithium metal.

2. The protective material according to claim 1, wherein the first protective layer comprises at least one of Li₃PO₄, a lithium n-octadecyl phosphonic acid, LiI, LiCl, LiBr, a polymeric organic acid salt containing a —COOLi group, ROLi, or RLi, wherein R comprises at least one of a linear or branched alkyl group, a cycloalkyl group, or an aryl group; and the second protective layer comprises at least one of an organic material or an organic-inorganic composite.

3. The protective material according to claim 2, wherein the organic material comprises at least one of polyethylene oxide, polyvinylidene fluoride-hexafluoropropylene copolymer, polydimethylsiloxane, polymethyl methacrylate, or polyionic liquid;
the organic-inorganic composite comprises at least one of the following composites: a composite of Al₂O₃ and polyethylene oxide, a composite of SiO₂ and polyethylene oxide, a composite of TiO₂ and polyethylene oxide, a composite of lithium bistrifluoromethanesulfonimide and polyethylene oxide, a composite of LiBF₄ and polyethylene oxide, a composite of LiClO₄ and polyethylene oxide, a composite of lithium aluminum germanium phosphate and polyethylene oxide, a composite of lithium aluminum titanium phosphate and polyethylene oxide, or a composite of lithium lanthanum zirconate and polyethylene oxide.

4. The protective material according to claim 1, further comprising one or more other protective layers, wherein the one or more other protective layers are located on a side of the second protective layer, opposite to the first protective layer.

5. The protective material for a negative electrode of a lithium metal battery according to claim 1, wherein a thickness of the protective material for a negative electrode is 0.02 microns to 200 microns; and the first protective layer has a thickness of 10 nanometers to 150 nanometers.

6. A method for manufacturing a protective material for a negative electrode, comprising:
(1) using a solution with a lithium metal cleaning function to clean a lithium metal surface to form a first protective layer; and
(2) coating the first protective layer with a second protective layer.

7. The method according to claim 6, wherein the solution with a lithium metal cleaning function comprises:
an ingredient A of a 0.05 wt % to 5 wt % concentration, wherein the ingredient A comprises at least one of naphthol, polyacrylic acid, polymethacrylic acid, naphthalene, n-octadecyl phosphoric acid, polyphosphoric acid, I₂, Br₂, or Cl₂; and
an ingredient B, wherein the ingredient B comprises at least one of acetonitrile, tetrahydrofuran, dimethyl sulfoxide, or N-methylpyrrolidone.

8. A negative electrode, comprising a protective material for the negative electrode of a lithium metal battery; the protective material comprises a first protective layer and a second protective layer adjacent to the first protective layer, wherein the first protective layer is contiguous to a lithium metal.

9. The negative electrode according to claim 8, wherein the first protective layer comprise at least one of Li₃PO₄, a lithium n-octadecyl phosphonic acid, LiI, LiCl, LiBr, a polymeric organic acid salt containing a —COOLi group, ROLi, or RLi, wherein R comprises at least one of: a linear or branched alkyl group, a cycloalkyl group, or an aryl group; and the second protective layer comprises at least one of an organic material, or an organic-inorganic composite.

10. The negative electrode according to claim 9, wherein the organic material comprises at least one of polyethylene oxide, polyvinylidene fluoride-hexafluoropropylene copolymer, polydimethylsiloxane, polymethyl methacrylate, or polyionic liquid;
the organic-inorganic composite comprises at least one of the following composites: a composite of Al₂O₃ and polyethylene oxide, a composite of SiO₂ and polyethylene oxide, a composite of TiO₂ and polyethylene oxide, a composite of lithium bistrifluoromethanesulfonimide and polyethylene oxide, a composite of LiBF₄ and polyethylene oxide, a composite of LiClO₄ and polyethylene oxide, a composite of lithium aluminum germanium phosphate and polyethylene oxide, a composite of lithium aluminum titanium phosphate and polyethylene oxide, or a composite of lithium lanthanum zirconate and polyethylene oxide.

11. The negative electrode according to claim 8, a thickness of the protective material for a negative electrode is 0.02 microns to 200 microns; and the first protective layer has a thickness of 10 nanometers to 150 nanometers.

12. An electrochemical apparatus, comprising the negative electrode according to claim 8.

13. An electronic device, comprising the electrochemical apparatus according to claim 12.
